(19) United States
(12) Patent Application Publication
(10) Pub. No.: US 2025/0293964 A1
(43) Pub. Date: Sep. 18, 2025

(54) Quality of Service Monitoring

(71) Applicants: Telefonaktiebolaget LM Ericsson (publ), Stockholm (SE); ERICSSON AB, Stockholm (SE)

(72) Inventors: Gregory Liokumovich, Oberursel (DE); Ulf Ericsson, Karlskrona (SE); Ajit Raghavan, New Delhi (IN)

(21) Appl. No.: 18/860,195

(22) PCT Filed: Apr. 27, 2022
(86) PCT No.: PCT/EP2022/061269

§ 371 Date: Oct. 25, 2024

(51) Int. Cl. H04L 43/16; H04L 43/0829; H04L 43/087

(52) U.S. Cl. CPC H04L 43/16; H04L 43/0829; H04L 43/087

(57) ABSTRACT

According to an aspect, there is provided a method of monitoring a quality of service metric for a communications service. The method comprises determining a plurality of performance metrics across a communications network providing the communications service, the performance metrics associated with coordinates of a dimension. Grouping the performance metrics by coordinate using a performance metric data structure (410). Determining the QoS metric for a first coordinate of the dimension using the grouped performance metrics in the performance metric data structure (415). Determining when the QoS metric for the first coordinate does not meet a QoS requirement (420).

### TECHNICAL FIELD

This disclosure relates to the monitoring of quality of service (QoS) in the provision of network services.

### BACKGROUND

Fifth generation (5G) telecommunications standards and associated technology introduce multiple new opportunities for Communication Service Providers (CSPs) to monetize connectivity or communications services. Some of these opportunities focus on business-to-business (B2B) and B2B2X (B2B to any end user) contracts, where a CSP sells services with specific qualities which could be technically implemented via dedicated Network Slices and services to the CSP's customers to either cover their own direct needs (B2B) or to be reused by them to serve their users (B2B2X).

CSPs need to agree with their customers on the service quality, which will be delivered by the service running on the Network Slice as well as on the consequences in case the service quality criteria could not be fulfilled. These agreements may be captured as part of a Service Level Agreement (SLA) which define the type of communications service to be provided as well as various quality requirements, for example using one or more using Service Level Objectives (SLO) to be met. However, such service provision and monitoring can become difficult as the number of CSP customers increases as well as variations in their situation such as geographical location or equipment.

Service providers may run Service Assurance Systems (SASs) to monitor the various network functions used to realize or otherwise provide services via their networks and to trigger actions to adjust network configuration or parameters to better meet service level obligations.

Limited SLA management functions are currently available to capture and monitor SLA obligations between a service provider and its customers. However, these functions are independent of service assurance and a number of unmet challenges complicate their use and limit their value. For example, available “closed loop service assurance” addresses the feedback loop between service orchestration and service assurance, with no connection to management of SLAs between a service provider and a customer. A further problem is that QoS metrics are typically only available in low level terms such as bandwidth which do not translate well to customer experience and may not map well to SLO.

Certain known approaches offer examples of formulating Key Performance Indicators (KQIs such as bandwidth or delay) having more relevance to overarching quality requirements. See the patent CN102546220B, for example. However, existing approaches do not relate such measurements to SLAs

### SUMMARY

In one aspect there is provided a method of monitoring a quality of service (QoS) metric for a network service. The method comprising determining a plurality of performance metrics across a network providing the network service, the performance metrics associated with coordinates of a dimension; grouping the performance metrics by coordinate using a performance metric data structure; determining the QoS metric for a first coordinate of the dimension using the grouped performance metrics in the performance metric data structure; and determining when the QoS metric for the first coordinate does not meet a QoS requirement.

Such a method advantageously enables network service performance to be monitored and if necessary tuned, based on grouping performance metrics by location, user device type or other dimensions. This enables a richer understanding of service performance and finer control.

In another aspect there is provided apparatus for monitoring a QoS metric for a network service in a network. The apparatus comprises a processor and memory configured to: determine a plurality of performance metrics at across the network providing the network service, the performance metrics associated with coordinates of a dimension; group the performance metrics by coordinate using a performance metric data structure; determine the QoS metric for a first coordinate of the dimension using the grouped performance metrics in the performance metric data structure; and determine when the QoS metric for the first metric does not meet a QoS requirement.

According to certain embodiments described herein there are also provided corresponding nodes, systems and apparatus. There is also provided a computer program comprising instructions which, when executed on a processor, causes the processor to carry out the methods described herein. The computer program may be stored on a non-transitory computer readable media.

Those skilled in the art will be aware of other benefits and advantages of the techniques described herein.

### BRIEF DESCRIPTION OF THE DRAWINGS

Some of the embodiments contemplated herein will now be described more fully with reference to the accompanying drawings, in which:

FIG. 1 is a schematic illustrating provision of a network service using a network according to an embodiment;

FIG. 2 is a schematic illustrating apparatus for monitoring a Quality of Service (QoS) metric for a network service according to an embodiment;

FIG. 3 illustrates a model defining transformation and aggregation functions for determining the QoS metric according to an embodiment;

FIG. 4 illustrates a method of monitoring a QoS metric for a network service according to an embodiment;

FIG. 5 is a signaling/sequence diagram of performance metric collection according to an embodiment;

FIG. 6 is a signaling/sequence diagram of QoS metric evaluation according to an embodiment;

FIG. 7 is a signaling/sequence diagram of Service Level Agreement (SLA) updating according to an embodiment;

FIG. 8 is a schematic illustrating building a performance metric tensor according to an embodiment; and

FIG. 9 is a schematic illustrating building a performance metric tensor and a performance quality metric tensor according to an embodiment.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Embodiments described herein relate the monitoring of quality of service (QoS) metrics for a network service and which is defined and provided across a network. The network operator and the service provider may be different entities, for example the network operator may be a 5G operator and the service provider may be a Communications Service Provider (CSP) operating a network slice to provide gaming connectivity to customers that require a certain minimum or at least a range of QoS metrics. The QoS metrics may be defined in a Service Level Agreement (SLA) which defines a service offered by the CSP to its customers, such as a gaming provider for example. The SLA defines certain “qualities” required of the service, for example “gamer” grade connection 99% of the time, with less than 5 occurrences of lower QoS in a time period such as one month. Determining compliance with this and other defined QoS metrics may be enabled by gathering performance metrics at the network level, such as bandwidth and delay, and grouping these by coordinates in different dimensions such as specific geographic locations, time frames, user equipment. This grouped information may be stored in data structures such as tensors, so that it may be analyzed by group to determine QoS metrics and any breaches of these defined in the SLA for example. This may result in reconfiguration of the underlying network or other actions such as automated self-tuning, healing and/or optimization loops to dynamically reconfigure the network to reduce SLA violation payments.

The monitored performance metrics, also known as Key Performance Indicators (KPI), may be grouped for example by City 1 and City 2 in the geographic location dimension; Mondays, Tuesdays etc in the time-frame dimension; and/or Smartphone, laptop, gaming console in the user equipment dimension. The grouped KPI may then be used to determine grouped performance quality metrics or Key Quality Indicators (KQI) in the respective dimension, for example KQI in City 1. These KQI may be calculated using a number of grouped KPI as well as other grouped KQI. For example a “gaming quality connection” KQI may be a value based on uplink speed, downlink speed and round trip latency. A Service Level Objective (SLO) may require this KQI to be above a threshold, for example at or above a threshold value for 99% of a month, and/or not dropping below the value more than 5 occasions in the month. Using the grouped approach, it can be determined whether SLO defined in an SLA are meet based on dimensions such as geographic location, time frame or user device type.

Embodiments enable the use of legacy KPI monitoring to enable better QoS monitoring of service provision without significant resource overhead, as well as more informed and better tailored remediation actions such as network reconfiguration, for example better geographic distribution of network resources. Embodiments also allow for easier implementation of updating of SLAs.

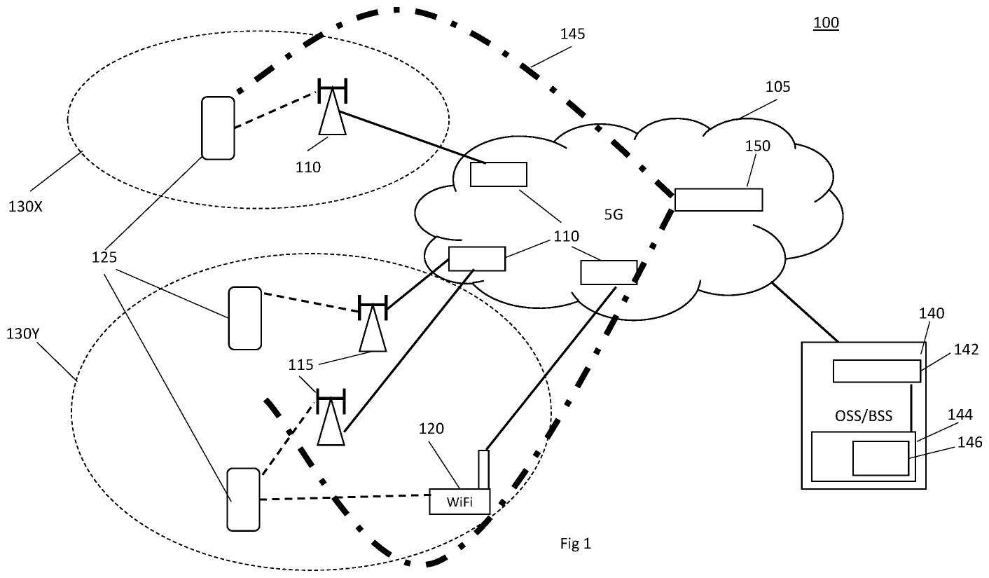

FIG. 1 illustrates provision of a network service over a network. The network 100 may be a 5G network comprising a network core 105 having gateways 110 coupled to base stations 115 which provide a radio access network (RAN) to nearby user equipment (UE) 125. The network may include other wireless network access such as WiFi™ 120. Similarly other network connections may include optical or copper cabling. The UE may connect to other UE coupled by the network 100, network resources 150 such as data and/or processing centers and data streaming servers. For example, a gaming connectivity service 145 may be provided between the network resource 150 and a number of UE 125. The network service 145 may be provided over different geographic locations 130X, 130Y. the network service may also be characterized in other dimensions such as by type of UE, for example Smartphone or Laptop, or time frame such as weekday or weekend.

Apparatus 140 may be associated with the network 100 which provides an Operational Support System (OSS) which assists with network operations and a Business Support System (BSS) which assists with CSP business support such as charging, billing, SLA management. The apparatus 140 comprises a processor and memory 144 and may be implemented on a single node or distributed over multiple nodes and/or other equipment. The memory may comprise instructions 146 configured to cause the processor to carry out various methods according to embodiments as described in more detail below.

Performance metrics may be gathered from various parts of the network, including for example RAN specific parameters as well as end-to-end parameters such as downlink speed between a UE 125 and the network equipment 150. The performance metrics may be gathered by the OSS and stored for later analysis by the BSS. Embodiments can take advantage of this legacy performance metric gathering and storage without significant resource overhead.

Other types of networks and network services may alternatively be used, for example a processing and data storage center, a streaming service, or any other electronic functionality.

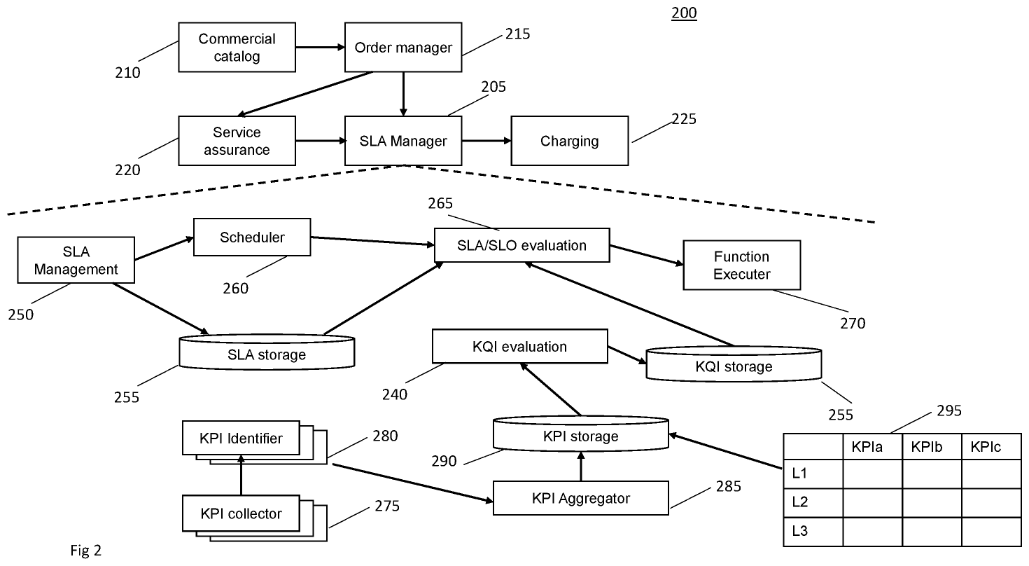

FIG. 2 illustrates an apparatus or system for monitoring a Quality of Service (QoS) metric for a network service according to an embodiment. The apparatus 200 may be distributed or located on a single node and comprises an SLA manager 205, a commercial catalog 210, an order manager 215, and a charger function 225, which may all be part of a BSS. In addition, a service assurance function 220 is provided which may be part of the OSS.

The commercial catalog 210 defines SLA specifications, the order manager 215 provisions newly created services and SLA instances to other parts of the system. The service assurance function 220 is an OSS node or part which is responsible for collecting performance metrics or KPIs. The SLA manager 205 calculates and executes respective SLA models to check compliance with the SLAs by monitoring one or more QoS metrics. The charging function 225 is part of the BSS and debits or credits customers of the network. Such users or customers may be service providers having their own subscribers that provide a network service using a network 100 managed in part by these functions 205-225. For example, a customer may provide a specific gaming connection service to its subscribers using a network slice of the network 100.

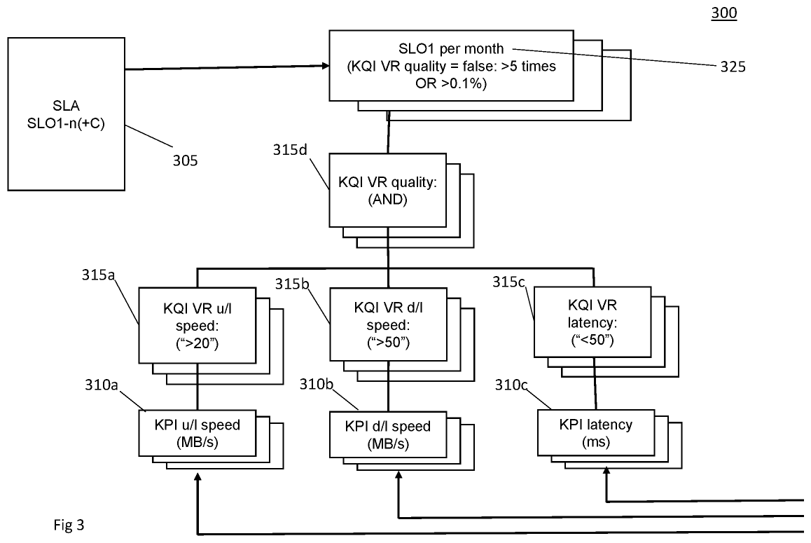

The SLA specification is based on KPI, KQI, transformation functions, aggregation functions, validation functions or thresholds. An SLA model is illustrated in FIG. 3 and includes an SLA specification 305, a number of SLO 325 for dimension, a number of KQI 315a-d for each dimension, and a number of KPI for each dimension. The service level agreement (SLA) specification is defined in the commercial catalog and offered to customers together with corresponding services (and products). The SLA specification comprises a number (1-n) of Service Level Objectives (SLO) and may also include consequences (+C) such as actions to take in response to breaches of the SLO's. A number of SLA instances or specifications may be stored and associated with different network products or services.

Each SLO, also known as a QoS metric, defines an objective for an associated performance metric or Key Quality indicator (KQI), as well as consequences (+C) if these objectives are not met. For example, one SLO1 325 is illustrated which is assessed once a month and specifies that 99.9% of the time per month the connectivity must be “KQI VR quality” (where VR is virtual reality) and that the connectivity performance can drop below this level more than 5 times per month. If the SLO is not meet, actions may be initiated as defined in the SLA, for example reconfiguring the network to improve connectivity or to credit the customer of the associated network product or service.

The state or assessment of the SLO 325 (e.g. true or false) is determined periodically as specified in the SLA and may be divided by coordinates of a dimension as illustrated, each box representing the result or state of the SLO assessment at a different coordinate of the dimension. Example dimensions include geographical location (e.g. city 1 or city 2), time frame (e.g. weekday or weekend); user equipment (e.g. Smartphone or gaming console).;

For simplicity the SLO state 325 is illustrated as being determined for three coordinates, for example three cities, along one dimension such as geographical location, however any number of dimensions and coordinates may be employed. For example, the SLO may be assessed by geographic location at fifty different coordinates (e.g. countries) along a geographical locations dimension and seven different coordinates (e.g. days of the week) along a time frame dimension.

A performance metric or KPI is a technical parameter describing the technical functioning of the network, measured or calculated, for example downlink bandwidth is currently 55 MB/s. Three different groups of KPI 310a-c are illustrated—uplink speed in MB/s, downlink speed in MB/s and latency in ms—however any suitable KPI may be employed depending on the SLO to be assessed. Other examples of KPI include: response time; packet loss; jitter; PDU (packet data unit) session success rate; API (application programmer interface) response time; failed requests rate; ticket response time and many others. The KPI are grouped by coordinate (e.g. city 1, city 2, city 3) along a dimension (e.g. geographic location). The KPI or performance metrics may be grouped and stored by more than one dimension. A convenient storage data structure may be a tensor, but other data structures may alternatively be used such as associative arrays. The data structure stores the KPI grouped by coordinate in each dimension used.

A KQI or performance quality metric is a service quality indicator (Boolean, numeric, etc) which indicates a current service quality. It can be either directly based on a KPI or can be calculated based on one or more KQIs in a KQI hierarchy. For example, KQI 315b “VR downlink speed” 315b may be calculated based on KPI 310b “downlink speed”—where the KPI is OK or “true” when the KPI value is greater than 50 MB/s. Similarly, KPI 315a “VR uplink speed” is true when KPI “uplink speed” is greater than 50 MB/s, and KQI 315c is true when KPI “latency”. In the model 300 illustrated, KQI 315d “VR quality” is true when KQI 315a “VR uplink” AND KQI 315b “VR downlink” AND KQI 315c “VR latency” are all true.

The KQI or performance quality metrics 315a-d are also grouped by coordinates along one or more dimensions, corresponding to the grouping of the KPI 310a-d. for example it may be determined whether KQI 315d “VR quality” is true at different geographical locations, for different user equipment or at different coordinates for other dimensions.

Each SLO is assessed by monitoring its corresponding KQI to determine whether or not the specified conditions are breached over the reporting period—for example whether “VR quality” is false more than 5 times or more than 0.1% of the period.

Returning to FIG. 2, in this embodiment, the SLA Manager 205 comprises the following modules which may be implemented as libraries, plugins, microservices, function-as-a-service. A SLA Management module 250 that registers SLAs to be monitored. A SLA storage module 255 that stores all registered SLA's. A SLA Scheduler 260 that triggers periodic processing, including SLO evaluation for example on monthly basis. A SLO evaluation module that evaluates if registered SLAs are violated or not. A Function executor module 270 which implements KQI transformation, SLO aggregation and SLO validation logic. This uses KQIs stored in KQI storage module 225.

A KPI collector module 275 which registers KPI information provided by the service assurance function 220. A KPI Identifier module 280 identifies which SLAs and SLOs are associated with the collected KPI. A KPI aggregator module 285 aggregates or groups the KPI by coordinates of one or more dimensions, such as geographic location or time frame. For example, in the geographic location dimension, the KP may be grouped by greater city regions covered by the network service—Stockholm; Malmo; Gothenburg. In another example the KPI may be grouped by time frame coordinates, such as weekday or weekend. The grouped KPI are then stored in a performance metric data structure 295 in a KPI storage module 290. The data structure 295 may be implemented as an associative array as shown, or a tensor for example. The KPI may be grouped in multiple dimensions, for example by geographic location, by time frame, by user equipment and so on. A multi-dimension tensor may be used to store the grouped KPI.

A KQI evaluation module 240 calculates KQI or performance quality metrics using the grouped KPI and may also use other KQI from the same group. The grouped KQI are stored in a KQI storage module 255 as a performance quality metric data structure which may also be a tensor or associative array for example. These grouped KQI are then used by the SLO evaluation module 265 and function executor 270.

The function executor is responsible for defining functions which can be referenced in the SLA model and for their execution during SLO evaluation. These include:
KQI transformation function which converts one or several KQI/KPI values into a new value, usually a Boolean or a float. For example: “greater than X”, “less than X”, “AND”, “OR”, “*1000”, “mean of all inputs”, “weighted summary of all inputs”
SLO aggregation function which defines a period of time and the logic of KQI aggregation needed for a given SLO. For example: “accumulate time during a year KQI has value X”, “count how many times during a month KQI changed its value from X to Y”, “find the longest duration a KQI kept value X during a month”.
SLO validation is applied to the result of SLO aggregation function and returns a boolean value which indicates if the SLO is violated or not. For example: “greater than 99%”, “less than 5 (times)”, “less than 10 mins”

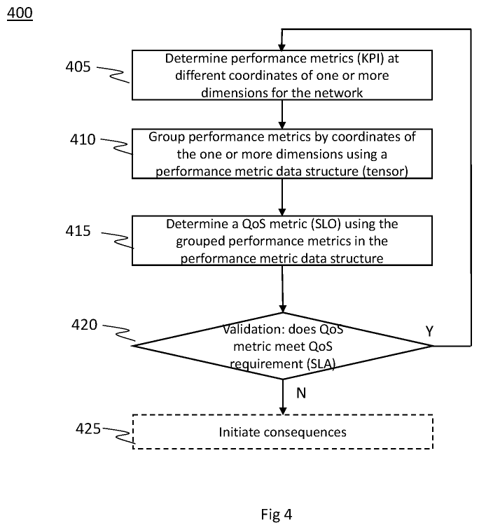

FIG. 4 illustrates a method of monitoring a QoS metric for a network service according to an embodiment. The method 400 may be implemented by the processor 142 or the SLA manager 205.

At 405, the method determines one or more performance metrics or KPI at different coordinates of one or more dimensions for the network. For example, the downlink speed of a network slice may be monitored for different cities, for different user equipment and/or for different levels of a service provided over the network slice.

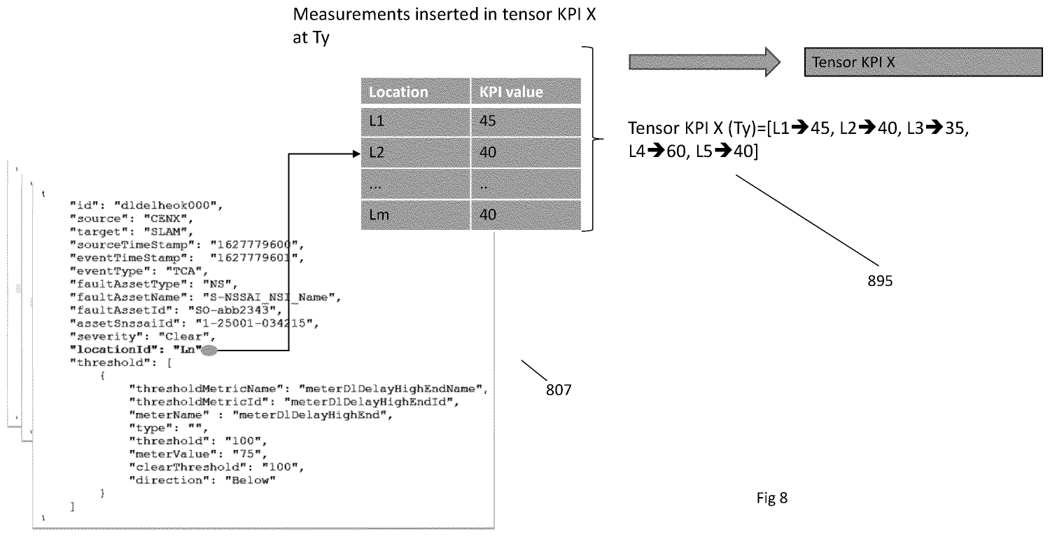

At 410, the method groups the KPI by coordinates of the one or more dimensions using a performance metric data structure such as a tensor-an example is illustrated in FIG. 8 which will be described in more detail below.

At 415, the method determines a QoS metric or SLO using the grouped performance metrics in the performance metric data structure. The QoS metric may be determined for respective coordinates of one or more dimensions using respective grouped KPI in the performance metric data structure. The QoS metric may be determined using a transformation function which transforms the grouped performance metrics or KPI at each measurement time (e.g. 1 s) into corresponding performance quality metrics or KQI for each measurement time as described above with respect to model 300 and FIG. 3. An aggregation function may be used to aggregate the KQI from each measurement time (e.g. 1 second) into a value or state for the QoS metric reporting period (e.g. 1 month). The aggregation function may count the number of times the KQI for each measurement period was below a threshold (e.g. 50 MB/s) and/or may divide this number by the total number of measurement periods in the reporting period to determine a percentage of time when the KQI was below the threshold.

The transformation function may generate a corresponding performance quality metric or KQI data structure into which KQI results are stored according to coordinates of one or more dimensions. Similarly, the results of the aggregation function may be stored in a QoS metric or SLO data structure again grouped by coordinates of one or more dimensions. These data structures may be tensors, associative arrays or any suitable form of data structure.

At 420, the method performs a validation function to determine whether or not the QoS metric meets a threshold or requirement defined in a corresponding SLO of the SLA specification. For example, is VR quality connectivity provided 99% of the time as specified in the SLA? If the QoS metric does meet the QoS requirement defined in the SLO (Y), then the method returns to 405 to continue monitoring the network and processing the KPI. If the QoS metric does not meet the QoS requirement (N), then the method moves to 425 where one or more consequences are initiated. Consequences may include reconfiguring the network slice to improve some connectivity parameter associated with the failed SLO, and/or may include crediting the user of the network slice over which a network service is provided.

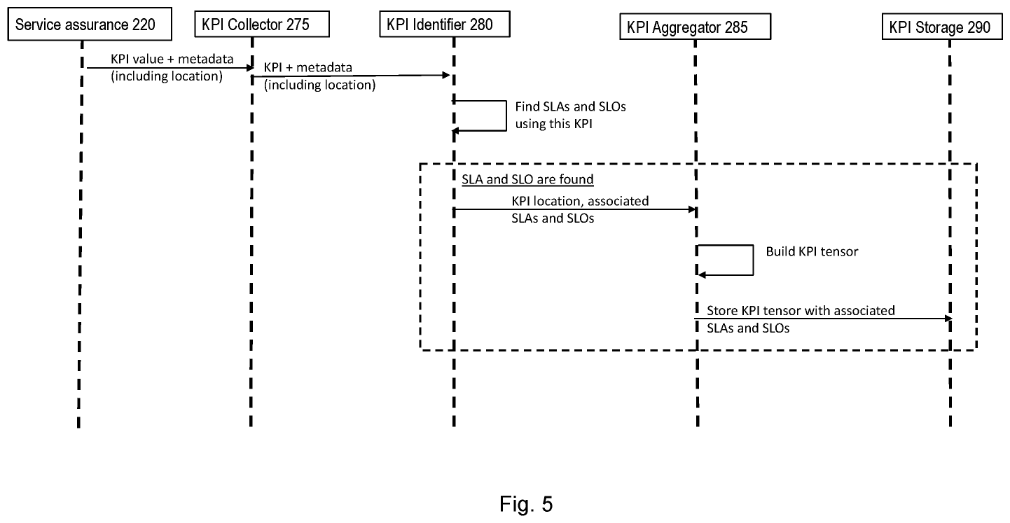

FIG. 5 illustrates a signaling/sequence diagram of performance metric collection according to an embodiment. This signaling involves the following previously described functions or modules: service assurance 220; KPI collector 275; KPI identifier; KPI aggregator 285; KPI storage 290.

The service assurance function 220 associated with the OSS forwards KPI values and metadata, such as location, to the KPI collector module 275 which is part of the BSS. The KPI collector 275 forwards this data to the KPI identifier 280 which determines which SLAs and SLOs require this information. Once the SLA and SLO are found, the KPI identifier sends the data to corresponding KPI aggregators 285 which build respective tensors or performance metric data structures to store the KPI values grouped by coordinates of one or more dimensions in the KPI storage 290.

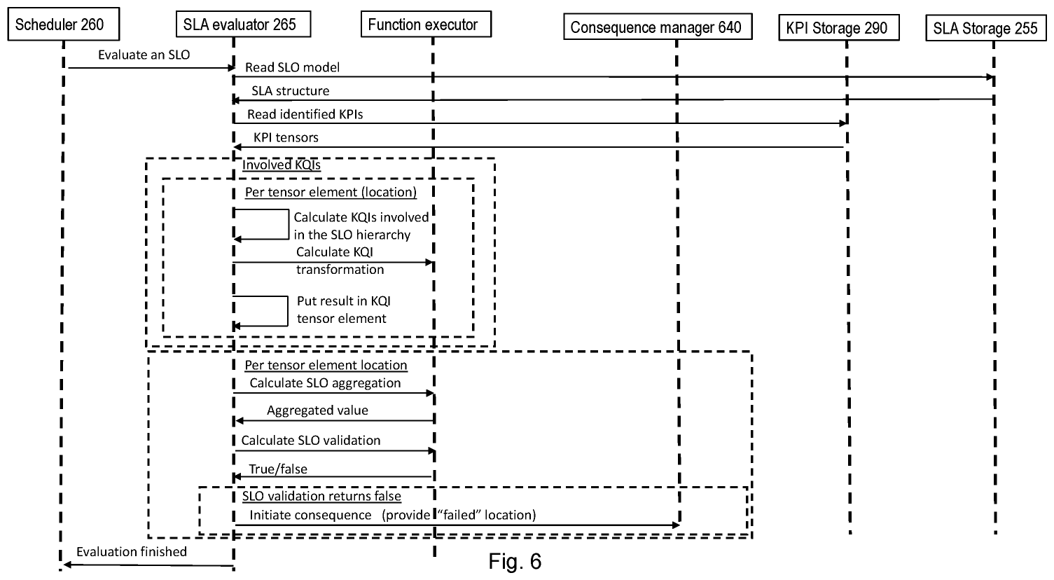

FIG. 6 is a signaling/sequence diagram of QoS metric evaluation according to an embodiment. This signaling involves the following previously described functions or modules: scheduler 260; SLO evaluation 265; function execution 270; KPI storage 290; SLA storage 255. Also involved is a consequence manager module 640 which determines consequences from the SLA in response to breaches of one or more SLO defined in the corresponding SLA and initiates these consequences. For example, a breach of a first QoS metric requirement SLO1 may require a credit to the customer purchasing the network slice from the CSP and a breach of second QoS metric requirement SLO2 may require additional resourcing for the network slice.

The scheduler 260 periodically triggers SLO evaluations defined in an SLA, for example monthly and forwards this to the SLA evaluator 265. The SLA evaluator 265 messages the SLA storage 255 to recover SLO models associated with the SLA. An example SLO model was illustrated in FIG. 3. Upon receiving the SLO models, the SLA evaluator 265 requests the associated KPI or performance metric values from the KPI storage, which may return an appropriate performance metric data structure such as a tensor which groups the KPI according to coordinates of one or more dimensions.

The evaluator 265 then builds a performance quality metric (or KQI) data-structure KQI for each SLO by calculating the KQI according to a model such as 300 for each SLO using the function executor 270. Each calculated KQI is stored as an element in the performance quality metric data structure such as a KQI tensor for each SLO, the KQI elements being grouped by coordinates in one or more dimensions in the same way as the KPI elements in the KPI tensor. The KQI transformations are defined in the SLA for each SLO, for example as previously described.

The evaluator 265 then determines QoS metrics using the KQI tensor. For each KQI tensor location, an aggregation function is applied and an aggregation value returns by the function executor 270 which may be stored in a corresponding QoS metric data structure. For example, one of the aggregated values for ‘VR quality” may be 5, corresponding to 5 occasions during the scheduled period when this did not meet a SLO requirement as previously described. Another aggregated value for “VR quality” may be 99.2% corresponding to the percentage of time above a SLO requirement. Again, these values may be grouped in an QoS metric tensor according to coordinates of one or more dimensions such as geographic location, time-frame or user equipment type.

The evaluator 265 signals the function executor to perform a validation function for each location of the KQI tensor using an appropriate SLO validation function. For example the combination of aggregated values 5 and 99.2% above may not meet a QoS metric requirement defined in the SLO of the SLA and so the function executor returns “false” for the QoS metric. The result of the validation function may trigger the SLA evaluator 265 to signal the consequence manager 640 to initiate an action as defined in the SLA. After all QoS metrics for each SLO of the SLA are assessed, the evaluator 265 signals the scheduler 260 that the SLA evaluation has been completed for the scheduled period.

This approach allows SLO assessment to be made for multiple coordinates for multiple dimensions to be made using largely legacy BSS structures with only minor architectural modifications such as the use of a KPI aggregator, a KPI tensor or performance metric similar data structure. Legacy transformation, aggregation and verification functions can also be used, though these are processed for multiple tensor element locations using grouped aware handling without the need for extra services or SLA instances.

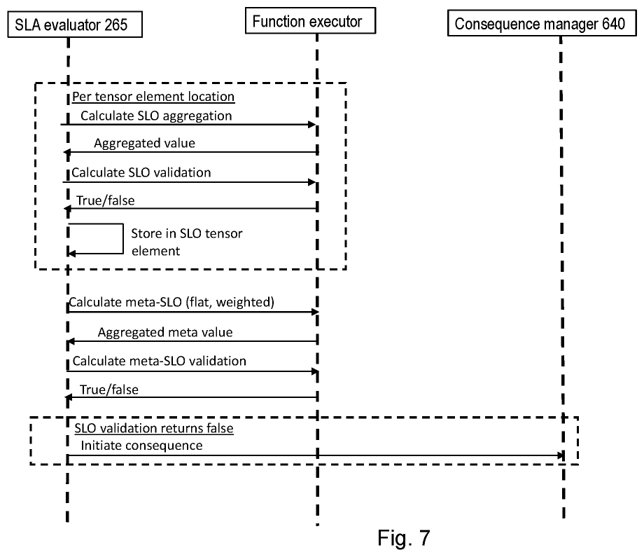

As an alternative or addition to per location consequence execution, the SLO may define consequences where too many individual tensor SLO requirements are breached. For example, consequences may be initiated if the “VR quality” SLO requirement is breached in more than 70% of locations. This may be achieved by transforming the QoS tensor evaluation results into a scaler using a dedicated aggregation function. This result may then be evaluated against a validation function. This is illustrated in FIG. 7 which modified the lower part of the sequence.

FIG. 8 illustrates building a performance metric tensor according to an embodiment. Performance metric data 807 comprising KPI values and metadata are received from various parts of the network. This data is processed, for example by the KPI collector 275 and KPI identifier 280 to recover a KPI value and a coordinate in one or more dimensions, in this example a location identifier or ID. The performance metric data 807 may be in the form of a reporting message which includes KPI values and grouping parameters such as location.

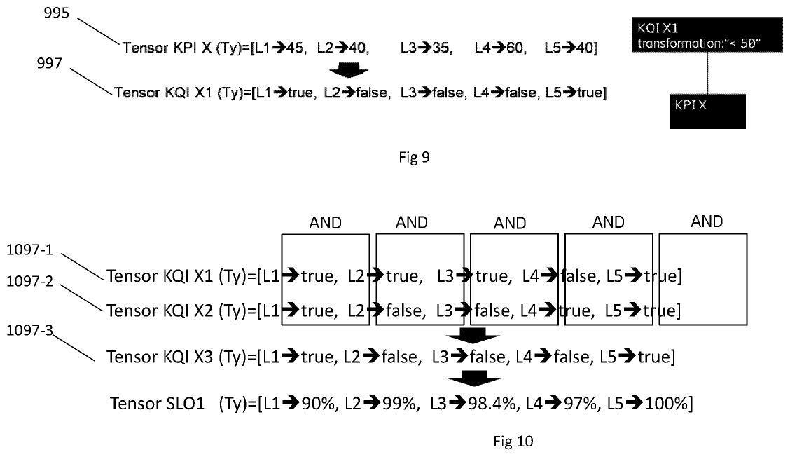

The values of each KPI, in this example KPI X at locations L1-Lm are indexed in a KPI tensor or other performance metric data structure, in this example KPI X 895 at time Ty as shown. In an example, the KPI's may be reported for all locations or coordinates of any other dimensions every 10 minutes. FIG. 9 illustrates tensor KQI transformation from a KPI tensor 995 and using a threshold comparison algorithm. The transformation results are stored in a performance quality data structure, in this example a KQI tensor 997.

FIG. 10 illustrates a tensor transformation using logical “AND” Two existing KQI tensors KQI X1 and X2 1097-1 and 1097-2 at respective locations are used as input for a third KQI tensor X3 1097-3. If both KQI X1 and X2 are “true” at that location, KQI X3 is also “true” at that location. The results for each location (or coordinates of another dimension) are stored in tensor 1097-3 for KQI X3. An SLO tensor dependent on KQI X3 may then be generated using a defined aggregation and validation function.

Embodiments may provide a number of advantages. For example multidimensional data processing aspects may be considered such as geographical distribution of the covered services in an SLA without significant resources overhead. The same SLA model may be used for SLAs which consider and do not consider geographical distribution (or other dimensions) of the service. This also reduces the impact to the monitoring functionality only. The same SLA monitoring algorithms (KQI transformation and SLO validations) may be used dimensionally grouped/distributed and ungrouped/undistributed services. These algorithms can be a significant part of SLA management functionality and therefore ability to reuse them is useful. Embodiments may allow balancing of geographical distribution pre-handing between service assurance and SLA management functions depending on their capabilities. Embodiments may allow the addition and removal of locations or other coordinates for different dimensions to be covered by an already monitored SLA without significant reconfiguration efforts. For example new device types may be added as new coordinates when they become available, and retired devices may result in coordinates being removed. A subset of the supported grouping criteria can be chosen during SLA negotiation. The number of chosen grouping criteria only impacts the KPI and other data structures. The SLA handling is performed the same way same way regardless of one or several grouping criteria.

Whilst the embodiments have described with respect to the location dimension, KPI, KQI and SLO can be gathered and calculated grouped by coordinates of different dimensions as well as multiple dimensions. This may be implemented using data structures such as multi-dimension tensors, although other data structures could alternatively be used such as associative arrays. Other dimensions may include time frame (e.g. Monday, Tuesday . . . Sunday or morning, afternoon, evening, night); user equipment (e.g. smartphone, tablet, laptop, gaming console, Apple™, Microsoft™)

Some or all of the described apparatus or functionality may be instantiated in cloud environments such as Docker, Kubernetes or Spark. This cloud functionality may be instantiated in the network edge, apparatus edge, or on a remote server coupled via a network such as 4G or 5G. Alternatively, this functionality may be implemented in dedicated hardware.

Modifications and other variants of the described embodiment(s) will come to mind to one skilled in the art having the benefit of the teachings presented in the foregoing descriptions and the associated drawings. Therefore, it is understood that the embodiment(s) is/are not limited to the specific examples disclosed and that modifications and other variants are intended to be included within the scope of this disclosure. Although specific terms may be employed herein, they are used in a generic and descriptive sense only and not for purposes of limitation.

1-30. (canceled)

31. A method of monitoring a quality of service (QoS) metric for a network service, the method comprising:
determining a plurality of performance metrics across a network providing the network service, the performance metrics associated with coordinates of a dimension;
grouping the performance metrics by coordinate using a performance metric data structure;
determining the QoS metric for a first coordinate of the dimension using the grouped performance metrics in the performance metric data structure;
determining when the QoS metric for the first coordinate does not meet a QoS requirement.

32. The method of claim 31, wherein the dimension is one or more of the following:
geographic location; time frame; device type.

33. The method of claim 31, wherein each performance metric is associated with a respective coordinate of a plurality of dimensions.

34. The method of claim 31, wherein the network performance metric comprises one or more of the following: downlink speed; uplink speed; delay; response time; packet loss; jitter; PDU session success rate; API response time; failed requests rate; customer ticket response time.

35. The method of claim 31, wherein determining the QoS metric comprises:
calculating a performance quality metric for the first coordinate using a transformation function applied to each element of a corresponding performance metric for the first coordinate in the performance metric data structure to generate a corresponding element for the first coordinate in a performance quality metric data structure;
calculating the QoS metric for the first coordinate using an aggregation function over a predetermined period applied to each element of a corresponding performance quality metric for the first coordinate in the performance quality metric data structure.

36. The method of claim 35, wherein calculating the QoS metric generates a corresponding element for the first coordinate in a QoS metric data structure.

37. The method of claim 35, wherein the performance quality metric for the first coordinate is associated with a threshold for the corresponding performance metric and the QoS metric for the first coordinate is associated with a number of times when and/or a duration when the performance quality metric did not meet the threshold.

38. The method of claim 35, comprising determining a plurality of QoS metrics and wherein the transformation function and the aggregation function for each QoS metric are defined in a model applied to corresponding elements for the coordinates of the dimension.

39. The method of claim 35, wherein the aggregation function generates a QoS metric data structure having elements corresponding to respective elements of the performance quality metric data structure.

40. The method of claim 31, wherein the performance metric data structure is a tensor or an associative array.

41. The method of claim 36, wherein the performance metric data structure, the performance quality metric data structure and the QoS metric data structure are each a tensor or an associative array.

42. An apparatus for monitoring a QoS metric for a network service in a network, the apparatus comprising a processor and memory configured to:
determine a plurality of performance metrics at across the network providing the network service, the performance metrics associated with coordinates of a dimension;
group the performance metrics by coordinate using a performance metric data structure;
determine the QoS metric for a first coordinate of the dimension using the grouped performance metrics in the performance metric data structure;
determine when the QoS metric for the first metric does not meet a QoS requirement.

43. The apparatus of claim 42, wherein the dimension is one or more of the following: geographic location; time frame; device type.

44. The apparatus of claim 42, wherein each performance metric is associated with a respective coordinate of a plurality of dimensions.

45. The apparatus of claim 42, wherein the processor and memory are configured to determine the QoS metric by:
calculating a performance quality metric for the first coordinate using a transformation function applied to each element of a corresponding performance metric for the first coordinate in the performance metric data structure to generate a corresponding element in a performance quality metric data structure;
calculating the QoS metric for the first coordinate using an aggregation function over a predetermined period applied to each element of a corresponding performance quality metric for the first coordinate in the performance quality metric data structure.

46. The apparatus of claim 45, wherein the processor and memory are configured to generate a corresponding element for the first coordinate in a QoS metric data structure when calculating the QoS metric.

47. The apparatus of claim 45, wherein the performance quality metric for the first coordinate is associated with a threshold for the corresponding performance metric and the QoS metric for the first coordinate is associated with a number of times when or a duration when the performance quality metric did not meet the threshold.

48. The apparatus of claim 45, wherein the processor and memory are configured to determine a plurality of QoS metrics and wherein the transformation function and the aggregation function for each QoS metric are defined in a model applied to corresponding elements of the coordinates of the dimension.

49. The apparatus of claim 45, wherein the aggregation function is configured to generate a QoS metric data structure having elements corresponding to respective elements of the performance quality metric data structure.

50. The apparatus of claim 42, wherein the performance metric data structure is a tensor or an associative array.
